(19) United States
(12) Patent Application Publication
(10) Pub. No.: US 2024/0171477 A1
(43) Pub. Date: May 23, 2024

(54) RENDERING AN AGGREGATE LINK CONSOLIDATING MULTIPLE LINKS TO REDUCE GRAPH CLUTTER AND SCALE AND IMPROVE RENDERING PERFORMANCE

(71) Applicant: VMware LLC, Palo Alto, CA (US)

(72) Inventors: Suresh Nagar, Sunnyvale, CA (US); Tea Liukkonen-Olmiala, Santa Clara, CA (US); Bo Jin, Santa Clara, CA (US); Shankar Vilayannur Natarajan, Milpitas, CA (US)

(21) Appl. No.: 17/989,792

(22) Filed: Nov. 18, 2022

(51) Int. Cl. H04L 41/22; H04L 9/40; H04L 41/12

(52) U.S. Cl. CPC H04L 41/22; H04L 41/12; H04L 63/0263

(57) ABSTRACT

Some embodiments provide a novel graphical user interface (GUI) for displaying a visual representation of machines in a set of one or more datacenters. The GUI includes a display area, and a graph that includes several clusters and different sets of connection links between different pairs of clusters. Each cluster represents a set of one or more machines in the datacenters. Each set of connection links between a pair of clusters (1) represents data message flows exchanged between machines in the pair of clusters, and (2) includes at least two different subsets of connection links that are displayed using different appearances corresponding to different categories of data message flows and indicating quantity of data message flows.

### BACKGROUND

When rendering a network graph in a graphical user interface (GUI), representing each data message flow exchanged in the network as its own individual connection link can clutter the graph and make it unreadable. There have been attempts to clear the clutter of connection links on the graph, such as edge bundling, rendering all links always, and not rendering links at a high scale. Edge bundling advocates merging the paths of common links in the middle, however, this does not reduce the number of links drawn on graph and makes it complicated to render because lines have to be converted to curves. This also does not provide different appearances for different categories of data message flows because the bundled edge is one single line. Rendering all links is not ideal because thousands of links make the graph appear cluttered. Not rendering links at a high scale leads to information loss because the user does not know how two clusters are linked at a high scale. Hence, methods and systems are needed for effectively visualizing data message flows exchanged between machines in a GUI.

### BRIEF SUMMARY

Some embodiments provide a novel graphical user interface (GUI) for displaying a visual representation of machines in a set of one or more datacenters. The GUI includes a display area, and a graph that includes several clusters and different sets of connection links between different pairs of clusters. Each cluster represents a set of one or more machines in the datacenters. Each set of connection links between a pair of clusters (1) represents data message flows exchanged between machines in the pair of clusters, and (2) includes at least two different subsets of connection links that are displayed using different appearances corresponding to different categories of data message flows and indicating quantity of data message flows.

The clusters of machines are generated in some embodiments based on an analysis of data message flows exchanged between the machines in the set of datacenters. In some embodiments, micro-segmentation is performed to divide machines into distinct groups based on shared characteristics, such as similar data message flows. An automated analysis is performed to identify and cluster the individual machines into these clusters presented in the graph.

Each set of connection links in some embodiments is represented as a set of parallel lines between its associated pair of clusters. Instead of displaying the lines between the individual machines, which can clutter the graph, they are drawn as a parallel set so the graph remains easy to view and analyze. In some embodiments, each set of connection links includes a first number of connection links representing a larger, second number of data message flows represented by the set of connection links, such that the first number is proportionally smaller to the second number. For example, if a first set of connection links is displayed to represent 1,000 data message flows between a first pair of clusters, the first set of connection links may include 50 connection links, and if a second set of connection links is displayed to represent 500 data message flows between a second pair of clusters, the second set of connection links would include 25 connection links. In this example, the ratio of connection links to data message flows is 1:20. This may be done to reduce clutter in the GUI by displaying less connection links than there are data message flows, and to help the user visualize which sets of machines have more data message flows being exchanged between each other. In other embodiments, all sets of connection links have the same number of connection links regardless of how many data message flows the sets of connection links represent. In such embodiments, this may be done to provide a more uniform way to display the data message flows.

A set of middlebox service rules in some embodiments is applied to the data message flows as they traverse the set of datacenters. In such embodiments, the different categories of data message flows include different actions applied to the data message flows based on the set of middlebox service rules. The set of middlebox service rules may be a set of firewall rules, a set of load balancing rules, network address translation rules, etc. In some embodiments, where a set of firewall rules is applied to the data message flows, a particular set of connection links between a particular pair of clusters displayed in the display area includes (1) a first subset of connection links displayed using a first appearance corresponding to allowed data messages exchanged between machines in the particular pair of clusters, (2) a second subset of connection links displayed using a second appearance corresponding to blocked data messages exchanged between machines in the particular pair of clusters, and (3) a third subset of connection links displayed using a third appearance corresponding to data messages exchanged between machines in the particular pair of clusters that were applied a default firewall rule. Unprotected data message flows are data message flows that do not match a particular existing firewall rule in the firewall rule set, and therefore have a default firewall rule applied to them. For example, if no firewall rule is defined for a data message flow between a particular machine in a first machine cluster and another particular machine in a second machine cluster, a default firewall rule is applied. In different embodiments, the default firewall rule allows, drops, or blocks the data messages of the flow.

In some embodiments, the first subset of connection links includes a first number of connection links indicating a first quantity of the allowed data message flows, the second subset of connection links includes a second number of connection links indicating a second quantity of the blocked data message flows, and a third subset of connection links includes a third number of connection links indicating a third quantity of the unprotected data message flows. As discussed previously, a set of connection links between a pair of clusters may include a smaller number of connection links than the number of flows they represent. Each category of flows may be allotted a certain number of those connection links for a user to visualize how many flows of each category are actually being exchanged between the machines in the pair of clusters. For example, if 50% of the flows are allowed, 30% are blocked, and 20% are unprotected, the set of connection links would include connection links where 50% of them are displayed using an appearance corresponding to allowed flows, 30% of them are displayed using an appearance corresponding to blocked flows, and 20% of them are displayed using an appearance corresponding to unprotected flows. This allows the user to visualize how many flows of each category are being exchanged, while still being able to view a less cluttered graph than if all flows were represented by their own connection link.

The different appearances of connection links can be one or more of different colors, different solid and dashed lines, and different thicknesses of lines. For example, different colors may be used to represent different actions taken based on firewall rules, such as green for allowed flows, blue for blocked flows, and red for unprotected flows. The graph may also or instead use different types of solid or dashed lines or varying thicknesses of lines to indicate the different actions taken. Any suitable appearance of a connection link may be used to display different categories of flows in the graph.

In some embodiments, the display area displays additional information regarding a particular set of connection links between a particular pair of clusters after the GUI detects a cursor action at a particular location in the display area that is within a threshold distance of the particular set of connection links. This cursor action may be a cursor click operation performed by a cursor at the particular location within the threshold distance, and may be a single or double click operation and a right or left click operation. In some embodiments, the particular set of connection links is not a selectable item in the display area of the GUI, so the GUI detects cursor click operations in the display area and determines if a click is near or over the particular set of connection links within a particular threshold distance. In other embodiments, the particular set of connection links is a selectable item in the GUI, and selection of the selectable item displays the additional information about the particular set of connection links.

The displayed additional information can be any suitable information about the set of connection links or the data message flows that the connection links represent. For instance, the additional information can include data indicative of the number of data message flows exchanged between the particular pair of clusters. As discussed previously, the number of connection links in a set of connection links is in some embodiments not the same number of data message flows it represents, so the additional information displayed in the display area shows the user the actual number of data message flows between machines in the cluster pair. Conjunctively or alternatively, the additional information can include data indicative of the numbers of data message flows represented by at least two different subsets of connection links. Because different categories of data message flows are represented using different appearances of different subsets of a given set of connection links, the additional information can let the user know how many actual data message flows are represented by each of those subsets.

In some embodiments, the sets of connection links are only displayed in the graph at one or more particular zoom levels of the display area. As a user zooms in and out of the graph in the display area, more or less detail may be included in the graph in order to keep the graph from appearing too cluttered. In some embodiments, in order to reduce clutter at zoomed-in levels of the graph, the graph may remove the sets of connection links from the graph as the user zooms closer on the graph. Similarly, at a first zoom level, the graph may not include the individual machines of the several clusters, and at a closer, second zoom level, the graph may include the individual machines. In doing so, a user can view a less cluttered graph when zoomed out and can view more detail regarding the clusters upon zooming into the graph. However, in other embodiments, the individual machines may always be shown in the clusters in the graph.

After detecting a cursor click operation at a particular location within a threshold distance of a particular machine displayed in the graph, the graph in some embodiments is updated to remove the sets of connection links between cluster pairs and to include a particular set of connection links representing data message flows exchanged between the particular machine and other machines in the set of datacenters. If a user clicks on a particular machine to view the data message flows associated with that particular machine, the graph updates to show those data message flows. The cluster pair connection link sets are removed in order to reduce clutter and make viewing the particular machine's data message flows easier.

In some embodiments, each data message flow associated with the particular machine is represented by a connection link displayed from the particular machine to another machine associated with the data message flow. More specifically, the particular set of connection links associated with the particular machine includes one connection link for every data message associated with the particular machine, and each link is displayed from the particular machine to the other machine associated with the connection link. In some embodiments, the connection links represent data message flows between the particular machine and other machines in the same cluster, the particular machine and other machines in different clusters, or both. These connection links may also be displayed using the different appearances corresponding to the different categories of data message flows. In the example of applying firewall rules to the data message flows, the particular set of connection links may then include connection links having different appearances corresponding to allowed, blocked, rejected, and/or unprotected data message flows.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings, and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an example of a network graph displayed in a GUI with unreadable connection links representing data message flows.

FIG. 2 conceptually illustrates a process of some embodiments for displaying a visual representation of machines in a set of one or more datacenters in a GUI.

FIG. 3 illustrates an example GUI displaying two machine clusters with a set of connection links representing data message flows exchanged between machines in the two machine clusters.

FIG. 4 illustrates an example GUI displaying a zoomed-out view of a network graph.

FIG. 5 illustrates an example GUI displaying a zoomed-in view of a network graph.

FIG. 6 illustrates an example GUI displaying several machine clusters and several sets of connection links between pairs of clusters.

FIG. 7 illustrates an example GUI displaying additional information regarding a particular set of connection links selected by a user in the GUI.

FIG. 8 illustrates an example GUI displaying connection links associated with a particular machine selected by a user in the GUI.

FIGS. 9A-C illustrate an example of the process of drawing a set of parallel connection links between two machine clusters.

FIG. 10 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel graphical user interface (GUI) for displaying a visual representation of machines in a set of one or more datacenters. The GUI includes a display area, and a graph that includes several clusters and different sets of connection links between different pairs of clusters. Each cluster represents a set of one or more machines in the datacenters. Each set of connection links between a pair of clusters (1) represents data message flows exchanged between machines in the pair of clusters, and (2) includes at least two different subsets of connection links that are displayed using different appearances corresponding to different categories of data message flows and indicating quantity of data message flows.

The machines can be virtual machines (VMs), containers, pods, nodes, etc., and the data message flows can also be referred to as connections or links between nodes. In a network graph at scale, there are thousands of nodes and hundreds of thousands of connections between them, e.g., a fully connected graph with N nodes have (N*(N−1))/2 edges (i.e., for 1000 nodes there can be almost half a million links).

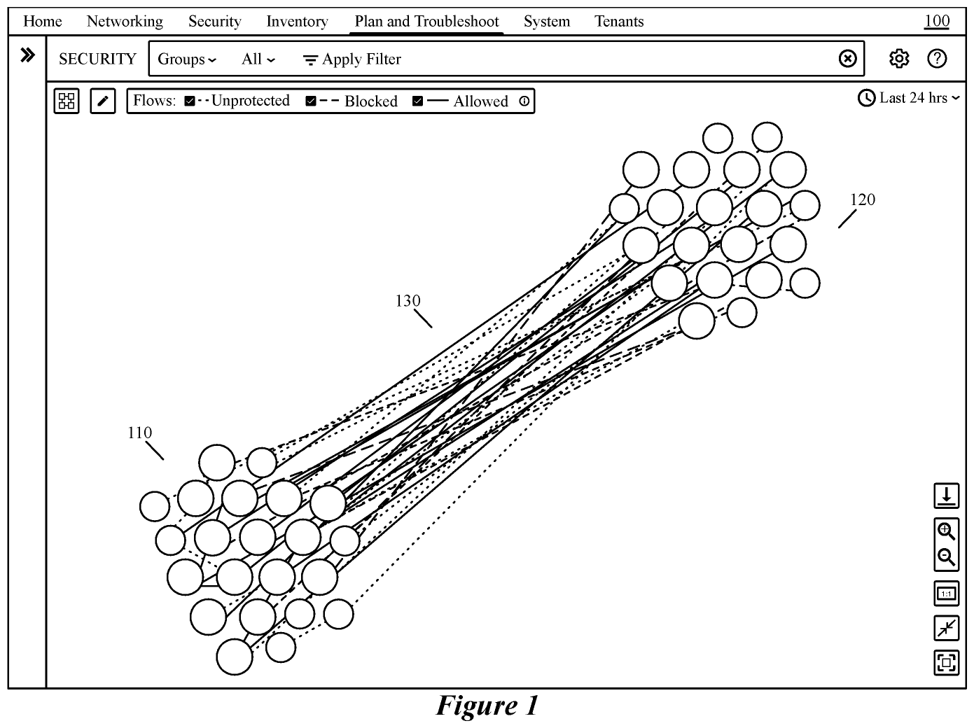

FIG. 1 illustrates an example of a network graph displayed in a display area of a GUI 100 as clusters of nodes 110 and 120 and their connection links 130 at scale. In some embodiments, machines of a set of datacenters are clustered or grouped together based on an analysis of the data message flows exchanged between the machines. Micro-segmentation in some embodiments is performed to divide machines into distinct groups based on shared characteristics, such as similar data message flows. An automated analysis is performed to identify and cluster the individual machines into these clusters presented in the graph. Micro-segmentation uses network virtualization techniques to create increasingly granular secure zones in datacenters and cloud deployments, which isolate each individual machine and secure it separately. In a zero trust model, a network is divided into small (or micro) segments and security is applied at the boundaries of each micro-segment. When groups of machines are generated based on this analysis, they can be displayed in a graph in a GUI display area, such as the machine clusters 110 and 120.

In a visualization graph (e.g., VMware, Inc.'s NSX Intelligence) which displays machines and their connection links, there are thousands of machines and connections between them. Each connection link represents a unique data message flow with, in some embodiments, a different appearance, such as a different color, a different solid or dashed line, or a different thickness of line to represent different categories of data message flows. For example, for a network graph that applies firewall rules to data messages, allowed data message flows can be represented in green, blocked data message flows can be represented in blue, and unprotected data message flows can be represented in red. Unprotected data message flows are data message flows that do not match a particular existing firewall rule in the firewall rule set, and therefore have a default firewall rule applied to them. For instance, if no firewall rule is defined for a data message flow between a particular machine in a first machine cluster and another particular machine in a second machine cluster, a default firewall rule is applied. In different embodiments, the default firewall rule allows, drops, or blocks the data messages of the flow. In this figure, allowed data message flows are solid lines, blocked data message flows are long dashed lines, and unprotected data message flows are short dashed lines.

However, representing each data message flow with its own connection link in a GUI graph causes the graph to be unreadable at scale. This adds cognitive overhead on the end user to scan connections to understand the graph. Because drawing thousands of data message flows is not readable at scale in a GUI graph, the solution in some embodiments is to draw an aggregate link between the clusters of nodes rather than viewing a “spaghetti” view of links. This provides a decluttered view of a large number of data message flows in a network graph by drawing them in a cleaner, more meaningful way.

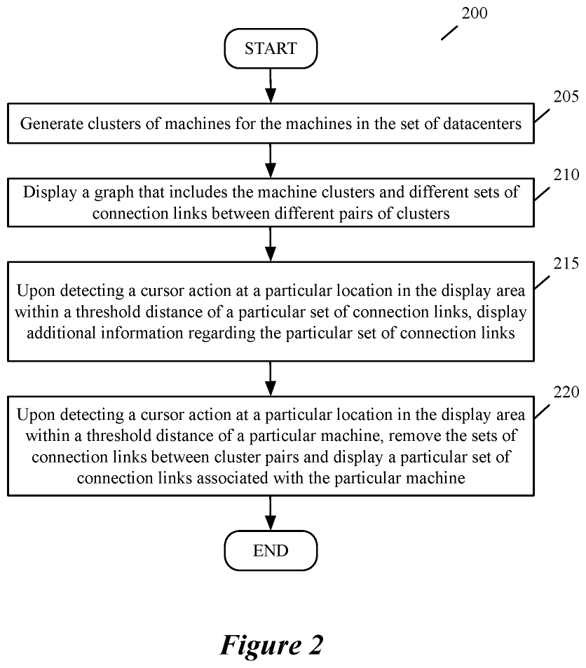

FIG. 2 conceptually illustrates a process 200 of some embodiments for displaying a visual representation of machines in a set of one or more datacenters in a GUI. This process 200 may be performed for any network graph that a user can render in a GUI. The process 200 begins by generating (at 205) several clusters of machines for the machines in the set of datacenters. The clusters in some embodiments are different clusters of machines generated using micro-segmentation, which can be performed to divide machines into distinct groups based on shared characteristics, such as similar data message flows. Micro-segmentation uses network virtualization techniques to create increasingly granular secure zones in datacenters and cloud deployments, which isolate each individual machine and secure it separately. In a zero trust model, a network is divided into small (or micro) segments and security is applied at the boundaries of each micro-segment. In other embodiments, other suitable clusters or groups of machines in datacenters can be used.

Next, the process 200 displays (at 210), in the display area of the GUI, a graph that includes the several machine clusters and different sets of connection links between different pairs of clusters. Each set of connection links between a pair of clusters (1) represents data message flows exchanged between machines in the pair of clusters, and (2) includes at least two different subsets of connection links that are displayed using different appearances corresponding to different categories of data message flows and indicating quantity of data message flows. A set of middlebox service rules in some embodiments is applied to data message flows as they traverse the set of datacenters. In such embodiments, the different categories of data message flows include different actions applied to the data message flows based on the set of middlebox service rules. The set of middlebox service rules may be a set of firewall rules, a set of load balancing rules, network address translation rules, etc.

In embodiments where a set of firewall rules is applied to the data message flows, a particular set of connection links between a particular pair of clusters displayed in the display area includes (1) a first subset of connection links displayed using a first appearance corresponding to allowed data messages exchanged between machines in the particular pair of clusters, (2) a second subset of connection links displayed using a second appearance corresponding to blocked data messages exchanged between machines in the particular pair of clusters, and (3) a third subset of connection links displayed using a third appearance corresponding to unprotected data messages exchanged between machines in the particular pair of clusters. In some embodiments, a fourth subset of connection links is displayed using a third appearance corresponding to rejected data messages exchanged between machines in the particular pair of clusters.

In some embodiments, the first subset of connection links includes a first number of connection links indicating a first quantity of the allowed data message flows, the second subset of connection links includes a second number of connection links indicating a second quantity of the blocked data message flows, and a third subset of connection links includes a third number of connection links indicating a third quantity of the unprotected data message flows. A set of connection links between a pair of clusters may include a smaller number of connection links than the number of flows they represent. Each category of flows may be allotted a certain number of those connection links for a user to visualize how many flows of each category are actually being exchanged between the machines in the pair of clusters. For example, if 50% of the flows are allowed, 30% are blocked, and 20% are unprotected, the set of connection links would include connection links where 50% of them are displayed using an appearance corresponding to allowed flows, 30% of them are displayed using an appearance corresponding to blocked flows, and 20% of them are displayed using an appearance corresponding to unprotected flows. This allows the user to visualize how many flows of each category are being exchanged, while still being able to view a less cluttered graph than if all flows were represented by their own connection link.

The different appearances of connection links can be one or more of different colors, different solid and dashed lines, and different thicknesses of lines. For example, different colors may be used to represent different actions taken based on firewall rules, such as green for allowed flows, blue for blocked flows, and red for unprotected flows. The graph may also or instead use different types of solid or dashed lines or varying thicknesses of lines to indicate the different actions taken. Any suitable appearance of a connection link may be used to display different categories of flows in the graph.

Upon detecting a cursor action at a particular location in the display area within a threshold distance of a particular set of connection links, the process 200 displays (at 215) additional information regarding the particular set of connection links. This cursor action may be a cursor click operation performed by a cursor at the particular location within the threshold distance, and may be a single or double click operation and a right or left click operation. In some embodiments, the particular set of connection links is not a selectable item in the display area of the GUI, so the GUI detects cursor click operations in the display area and determines if a click is near or over the particular set of connection links within a particular threshold distance. In other embodiments, the particular set of connection links is a selectable item in the GUI, and selection of the selectable item displays the additional information about the particular set of connection links.

In some embodiments, an information window is displayed in the GUI display area to display the additional information about the particular set of connection links. The displayed additional information for a set of connection links can be any suitable information about the set of connection links or the data message flows that the connection links represent. For instance, the additional information can include data indicative of the number of data message flows exchanged between the particular pair of clusters. As discussed previously, the number of connection links in a set of connection links is in some embodiments not the same number of data message flows it represents, so the additional information displayed in the display area can also show the user the actual number of data message flows between machines in the cluster pair. Conjunctively or alternatively, the additional information can include data indicative of the numbers of data message flows represented by at least two different subsets of connection links. Because different categories of data message flows are represented using different appearances of different subsets of a given set of connection links, the additional information can let the user know how many actual data message flows are represented by each of those subsets.

Upon detecting a cursor action at a particular location in the display area within a threshold distance of a particular machine, the process 200 removes (at 220) the sets of connection links between cluster pairs and displays a particular set of connection links associated with the particular machine. In some embodiments, a GUI is able to modify a graph based on a cursor action taken by a user on the graph. For instance, at 220, the graph is updated to remove the sets of connection links between cluster pairs and to include a particular set of connection links representing data message flows exchanged between the particular machine and other machines in the set of datacenters. If a user clicks on a particular machine to view the data message flows associated with that particular machine, the graph updates to show those data message flows. The cluster pair connection link sets are removed in order to reduce clutter and make viewing the particular machine's data message flows easier.

In some embodiments, the set of connection links associated with the particular machine includes one connection link for every data message associated with that machine, and each link is displayed from the particular machine to the other machine associated with the connection link. Connection links may be represented for data message flows between the particular machine and other machines in the same cluster, the particular machine and other machines in different clusters, or both. These connection links may be displayed using the different appearances corresponding to the different categories of data message flows. In some embodiments, only displaying connection links for individual flows upon user interaction ensures that users can still view individual links if required. This improves performance as individual links are not rendered for large amounts of data message flows, making the graph much more responsive without any information loss.

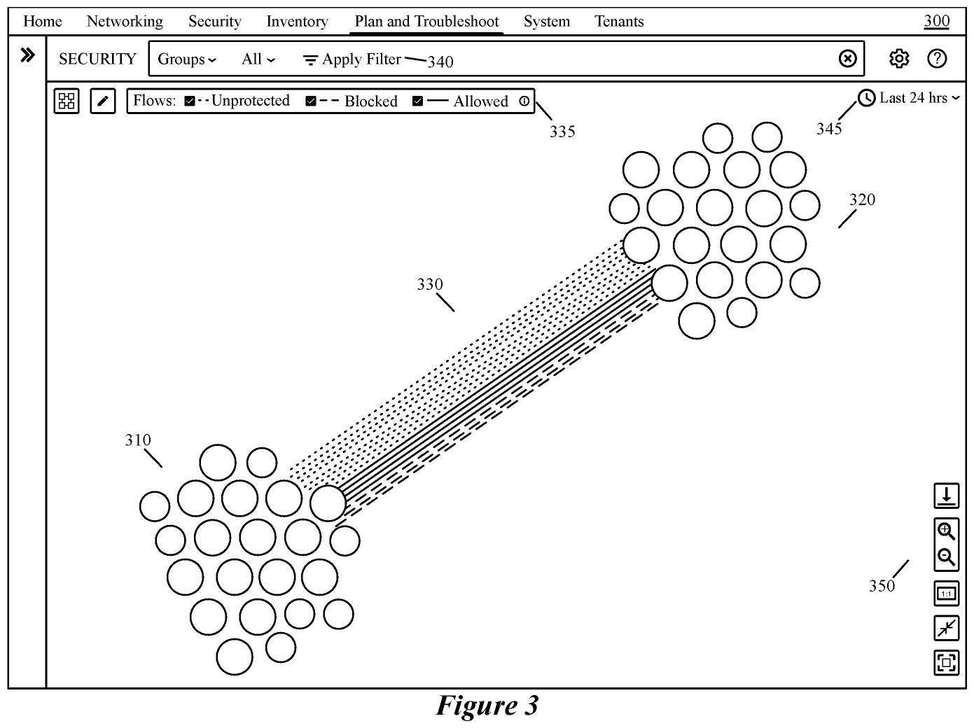

FIG. 3 illustrates an example GUI display area 300 of two machine clusters 310 and 320 that are identified in a graph with multiple links between the nodes of the clusters. A graph displayed in a GUI can include any number of machine clusters with any number of machines in each cluster. In some embodiments, each machine in the clusters 310 and 320 is represented using an appearance that corresponds to an aspect about the machine. For example, different appearance can correspond to different types of machines (e.g., VMs, containers, pods, etc.). Different appearances can also correspond to source, destination, and intermediate machines of data message flows. Different appearances can also correspond to whether they allow, block, or reject data messages based on firewall rules applied to the data messages. Different appearances can be different colors, different dashed or solid lines, different thicknesses of lines, different sizes, etc. In other embodiments, machines in the clusters 310 and 320 are represented using only a single appearance.

To represent all data message flows between the machines in the clusters 310 and 320, a set of connection links 330 is displayed as a set of parallel lines between the clusters. Instead of displaying the lines 330 between the individual machines, which can clutter the graph, they are drawn as a parallel set so the graph remains easy to view and analyze in the GUI display area 300. In some embodiments, a set of connection links includes a first number of connection links representing a larger, second number of data message flows represented by the set of connection links, such that the first number is proportionally smaller to the second number.

For example, if a first set of connection links is displayed to represent 1,000 data message flows between a first pair of clusters, the first set of connection links may include 50 connection links, and if a second set of connection links is displayed to represent 500 data message flows between a second pair of clusters, the second set of connection links would include 25 connection links. In this example, the ratio of connection links to data message flows is 1:20. This may be done to reduce clutter in the GUI by displaying less connection links than there are data message flows, and to help the user visualize which sets of machines have more data message flows being exchanged between each other. In other embodiments, all sets of connection links have the same number of connection links regardless of how many data message flows the sets of connection links represent. In such embodiments, this may be done to provide a more uniform way to display the data message flows.

In this figure, there are 15 total lines in the set of connection links 330 to represent 300 data message flows exchanged between the machines in the clusters 310 and 320. There are 4 allowed connection links, 3 blocked connection links, and 8 unprotected links. By viewing the data message flows in this manner, a user can determine which action is being applied to the most data message flows, and take necessary action if needed. Using the ratio of total number of connection links to total number of data message flows (i.e., 1:20 in this example), the user can deduce that there are 80 allowed data message flows, 60 blocked data message flows, and 160 unprotected data message flows. Because most of the connection links here are drawn as unprotected connection links, a user can determine that a majority of data messages are being applied a default firewall rule instead of a firewall rule specific to its source and destination. Knowing this information, the user can define additional firewall rules for the network, which can enhance security of the network.

In some embodiments, a GUI display area 300 also provides different filters and selectable items for a user to customize the view of a network graph. A connection link category filter 335 can filter which types of data message flows are represented in the set of connection links 330. This figure shows a selection of all three categories of data message flows. An apply filter 340 allows a user to filter what types of machines or machine clusters are included. For instance, if the user wishes to only view VMs, and no containers or pods, the user can use the apply filter 340 to accomplish this, and the GUI will display an updated network graph based on the filters and parameters set by the user. In this figure, no filters have been applied. The GUI display area 300 can also include a time filter 345, for a user to view the network graph and its data message flows at different time periods. This figure shows the network and its data message flows within the last 24 hours. If a user decides to view the network graph during a different time period, the user uses the time filter 345 to update the displayed graph. The GUI display area 300 can also include several selectable items 350, which can download the current graph as an image, zoom the graph in and out, show the graph in a 1:1 scale, minimize the window of the GUI display area 300, and any other suitable selectable items for displaying a network graph in a GUI.

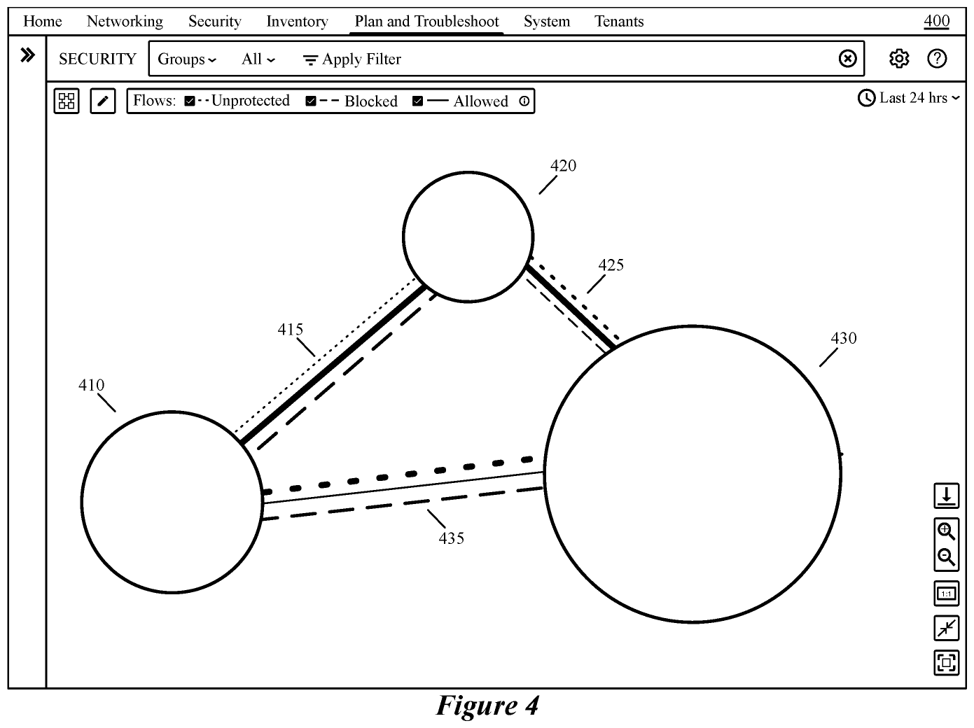

A graph displayed in a GUI in some embodiments can be altered depending on the zoom level of the graph. As a user zooms in and out of the graph in the display area, more or less detail may be included in the graph in order to keep the graph from appearing too cluttered. For instance, at a first zoom level, the graph may not include the individual machines of the several clusters, and at a closer, second zoom level, the graph may include the individual machines. FIG. 4 illustrates an example GUI display area 400 that shows a zoomed-out view of a network graph. Instead of displaying individual machines of clusters, clusters 410, 420, and 430 are shown as just single items because individual machines displayed at further zoomed-out levels are not readable by the user.

The sets of connection links 415, 425, and 435 are also displayed in a less cluttered way at a zoomed-out level in some embodiments. In this figure, instead of displaying a certain number of connection links for each subset based on the number of data message flows they represent, only one connection link is displayed for each data message flow category. Because of this, the thickness of each line varies to display to the user how many data message flows each line represents. For the set of connection links 415 between clusters 410 and 420, the solid dashed line, for allowed data message flows, is the thickest, meaning that a majority of flows between the two clusters are allowed. The short dashed line, for unprotected data message flows, is the thinnest to show that the least amount of flows are unprotected.

For the set of connection links 425 between clusters 420 and 430, the majority of flows are shown to be allowed flows, while the least amount of flows are blocked. For the set of connection links 435 between clusters 410 and 430, the majority of flows are displayed to be unprotected flows, while the least amount of flows are allowed. Using this information, the user can modify or define additional firewall rules as the user sees fit. By displaying the clusters and sets of connection links more generally, the user can view a less cluttered graph when zoomed out, and can view more detail regarding the clusters upon zooming into the graph. However, in other embodiments, the individual machines may always be shown in the clusters in the graph displayed in the GUI.

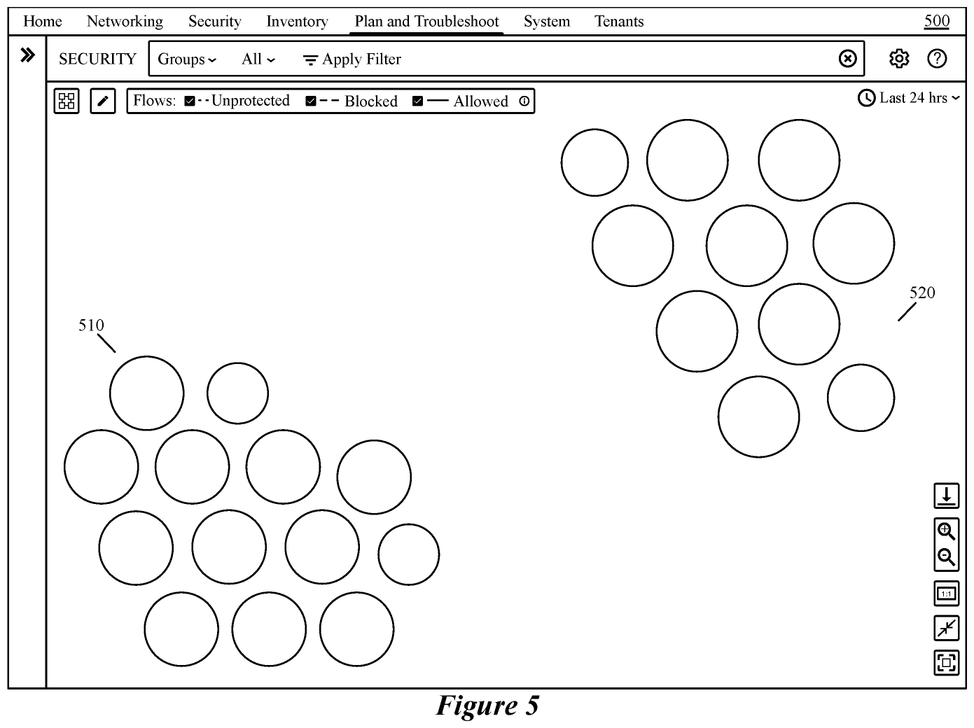

In some embodiments, in order to reduce clutter at zoomed-in levels of the graph, the graph may remove the sets of connection links from the graph as the user zooms closer on the graph. FIG. 5 illustrates another GUI display area 500 in which a graph has been zoomed in by the user. Clusters 510 and 520 are displayed, and each individual machine is displayed for each cluster. However, a set of connection links is not displayed between the two clusters 510 and 520. In some embodiments, connection links are only displayed at certain zoom levels, and as a user zooms in to a particular zoom level, the connection links are removed from the graph.

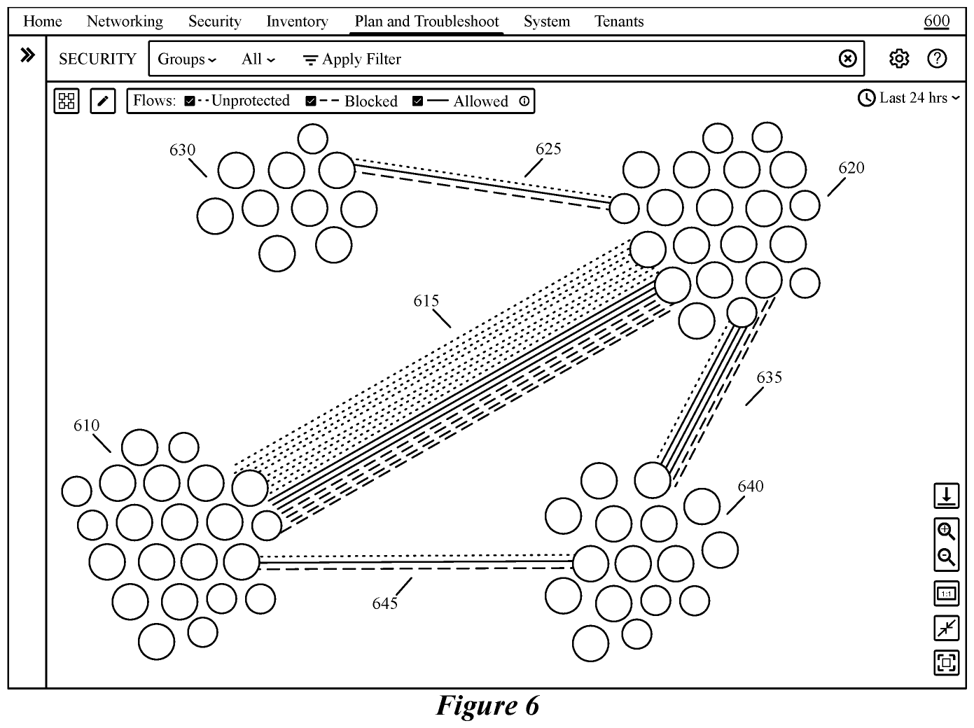

As discussed previously, a GUI can display a graph that includes multiple machine clusters and multiple sets of connection links. FIG. 6 illustrates a GUI display area 600 with four machine clusters 610, 620, 630, and 640, and four sets of connection links 615, 625, 635, and 645. Each machine cluster is shown to include the individual machines in the cluster. For example, cluster 610 shows 22 circles for 22 machines in the cluster, while cluster 630 shows 10 circles for 10 machines in this cluster. In some embodiments, different sets of connection links include a different number of lines. Connection link set 615 between clusters 610 and 620 includes the most connection links, indicating that more data message flows are exchanged between these clusters than the other clusters in the graph. Connection link sets 625 and 645 include the least number of connection links, indicating that the associated pairs of clusters exchange the least amount of data messages than the other pairs of clusters. In other embodiments, all sets of connection links have the same number of connection links regardless of how many data message flows the sets of connection links represent. This may be done to provide a more uniform way to display the data message flows. However, displaying different numbers of connection links in different sets of connection links provides to the user more information about the amount of data message flows being exchanged between pairs of clusters.

In some embodiments, a GUI display area displays additional information regarding a particular set of connection links between a particular pair of clusters after the GUI detects a cursor action at a particular location in the display area that is within a threshold distance of the particular set of connection links. This cursor action may be a cursor click operation performed by a cursor at the particular location within the threshold distance, and may be a single or double click operation and a right or left click operation. In some embodiments, the particular set of connection links is not a selectable item in the display area of the GUI, so the GUI detects cursor click operations in the display area and determines if a click is near or over the particular set of connection links within a particular threshold distance. In other embodiments, the particular set of connection links is a selectable item in the GUI, and selection of the selectable item displays the additional information about the particular set of connection links.

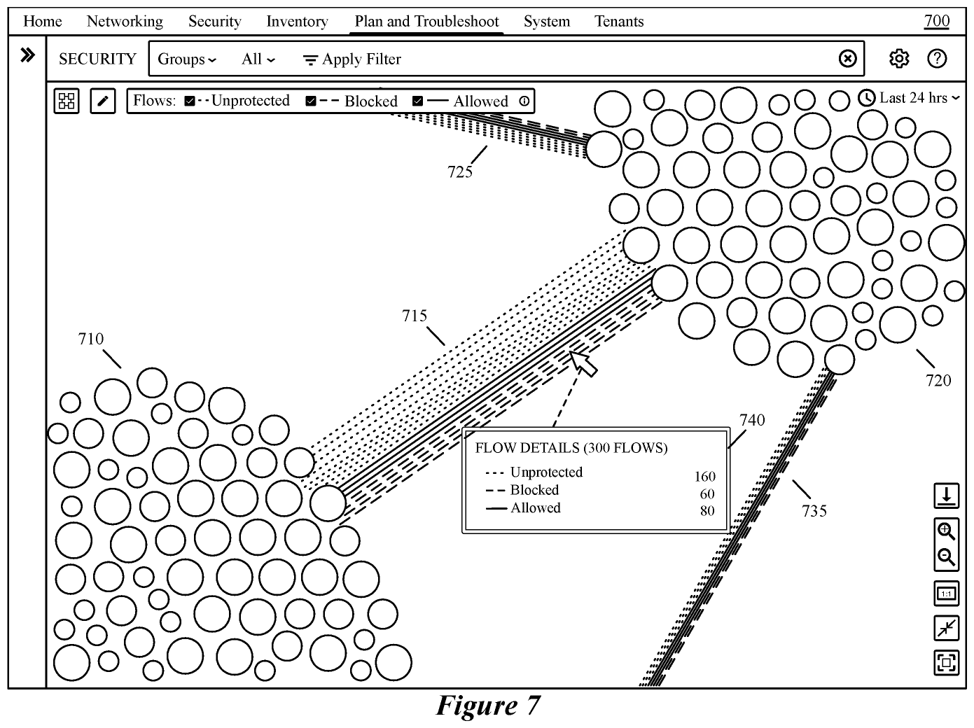

FIG. 7 illustrates a GUI display area 700 displaying two clusters 710 and 720, and three sets of connection links 715, 725, and 735. In this example, a user has zoomed in on the graph in the display area 700, causing only two clusters 710 and 720 to be visible. Connection link sets 725 and 735 are shown to be associated with cluster 720, but the other clusters are not displayed because of the particular zoom level of the graph. If a user were to zoom out, these other clusters may also be displayed. In this figure, a user has hovered a cursor over the set of connection links 715, causing an information window 740 to be displayed. The threshold distance for this set of connection links 715 may be only the area of the display area 700 covered by the connection link set, or may also include some of the surrounding area. Using the detection of a cursor over the threshold distance of a component of the graph, the GUI is able to determine when a user is interacting with a component in order to perform an action based on the interaction. In other embodiments, the set of connection links is a selectable GUI item, such that the GUI knows when a user hovers over or clicks on the item and is able to perform an action based on that.

This information window 740 is displayed in the GUI display area 700 to display additional information about the selected graph component, i.e., the set of connection links 715. The displayed additional information for a set of connection links can be any suitable information about the set of connection links or the data message flows that the connection links represent. For instance, the additional information can include data indicative of the number of data message flows exchanged between the particular pair of clusters. As discussed previously, the number of connection links in a set of connection links is in some embodiments not the same number of data message flows it represents, so the additional information displayed in the display area can also show the user the actual number of data message flows between machines in the cluster pair. Conjunctively or alternatively, the additional information can include data indicative of the numbers of data message flows represented by at least two different subsets of connection links. Because different categories of data message flows are represented using different appearances of different subsets of a given set of connection links, the additional information can let the user know how many actual data message flows are represented by each of those subsets. In this example, the information window 740 displays the total number of flows represented by the connection link set 715, and the total number of each data message flow category (i.e., allowed, blocked, and unprotected flows).

In some embodiments, a GUI is able to modify a graph based on a cursor action taken by a user on the graph. For instance, after detecting a cursor click operation at a particular location within a threshold distance of a particular machine displayed in the graph, the graph in some embodiments is updated to remove the sets of connection links between cluster pairs and to include a particular set of connection links representing data message flows exchanged between the particular machine and other machines in the set of datacenters. If a user clicks on a particular machine to view the data message flows associated with that particular machine, the graph updates to show those data message flows. The cluster pair connection link sets are removed in order to reduce clutter and make viewing the particular machine's data message flows easier.

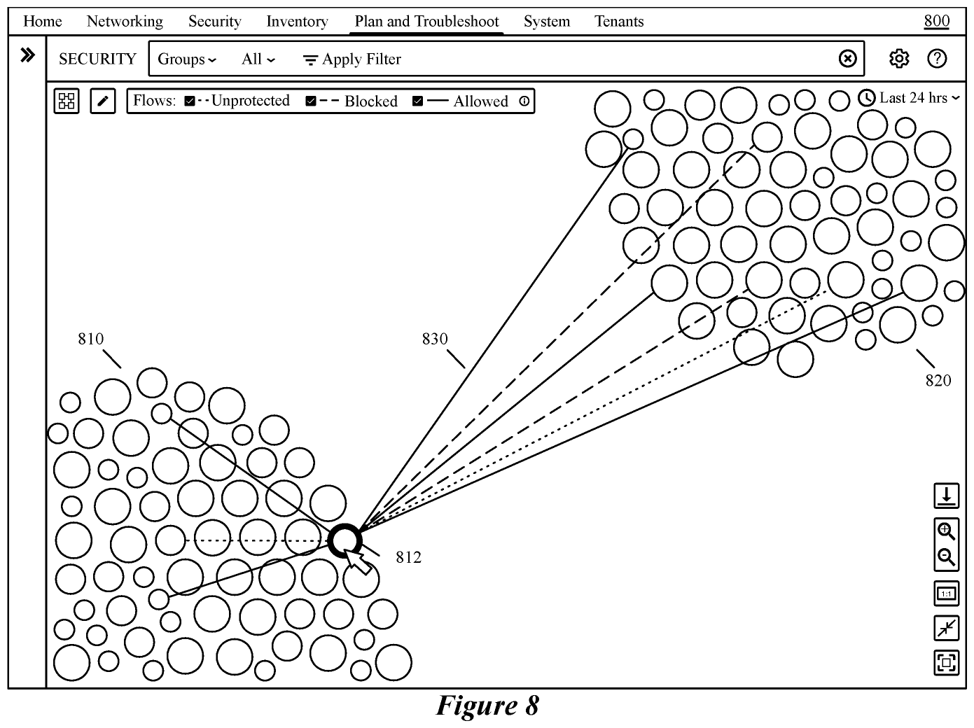

FIG. 8 illustrates a GUI display area 800 displaying a pair of clusters 810 and 820. In this figure, a user has clicked on a particular machine 812 in the first cluster 810. After the GUI detects this cursor action, all connection link sets between cluster pairs are removed, hence, there is no set of connection links representing all flows exchanged between the clusters 810 and 820. The GUI also updates the graph to include a set of connection links 830 representing data message flows exchanged between the selected machine 812 and other machines in the clusters 810 and 820. In some embodiments, this ensures that there is no information loss and allows users to see individual links if required. This improves performance as individual links are not rendered for large amounts of data message flows, making the graph much more responsive without any information loss.

In some embodiments, each data message flow associated with the machine 812 is represented by its own connection link displayed from the machine 812 to another machine associated with the data message flow. More specifically, the set of connection links 830 associated with the machine 812 includes one connection link for every data message associated with the machine 812, and each link is displayed from the machine 812 to the other machine associated with the connection link. In some embodiments, connection links are represented for data message flows between the machine 812 and other machines in the same cluster, the machine 812 and other machines in different clusters, or both. In this example, the connection link set 830 includes links for all flows associated with the machine 812, including flows exchanged between machines in its own cluster 810.

These connection links in the set 830 may be displayed using the different appearances corresponding to the different categories of data message flows. In the example of applying firewall rules to the data message flows, the particular set of connection links may then include connection links having different appearances corresponding to allowed, blocked, rejected, and/or unprotected data message flows. As shown in this figure, allowed, blocked, and unprotected flows are represented as solid, long dashed, and short dashed lines, respectively.

In some embodiments, an aggregate set of connection links displayed between two machine clusters in a GUI are displayed as a set of parallel lines. An aggregate link is not a single line as rendered in many other libraries/solutions. It is a set of many lines drawn together in parallel. In some embodiments, a line from the center of a first machine cluster to the center of a second cluster intersecting at the circumference of the clusters is an easy alternative. However in some embodiments, to draw an aggregate link, many points are found on the circumference of both clusters and the lines are drawn across those points to make it appear like one consolidated link. This keeps the aesthetic of a single link, yet multiple lines are drawn with different colors to provide information about the consolidated flow status.

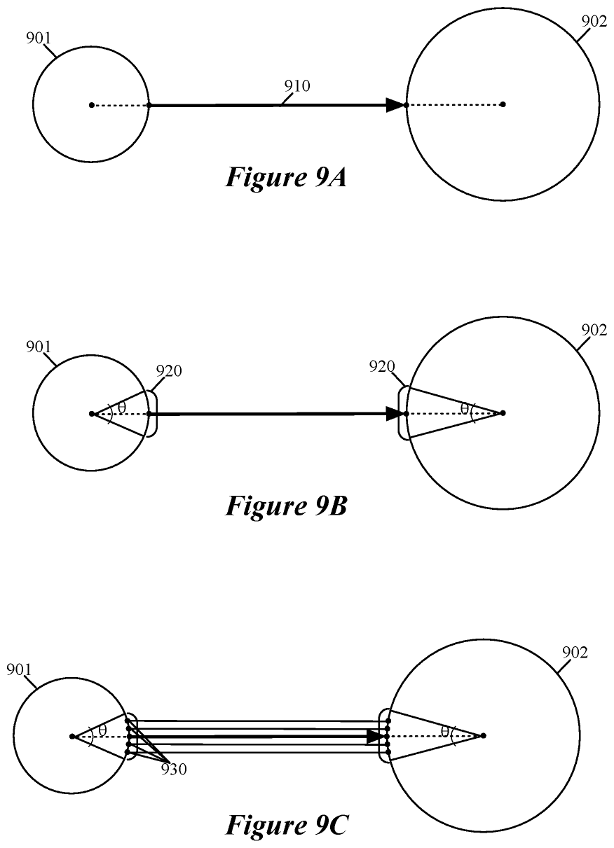

FIG. 9A-C illustrate an example of the process of drawing a set of parallel connection links between two clusters 901 and 902. In some embodiments, two machine clusters are represented by the same sized circles, however, in other embodiments (as shown in these figures), the machine clusters can be represented by different sized circles. As shown in FIG. 9A, a vector 910 is first determined on the circumference of the clusters 901 and 902 that intersects with a link drawn from the center of the two clusters. Next, as shown in FIG. 9B, the height 920 of the set of connection links is calculated. For this, the angle theta (θ) is calculated for the arc length equal to height of the set of connection links. Next, angle θ is divided by the number of connection links in the set of connection links, which gives the angle delta (∂). The vector 910 calculated in FIG. 9A is then rotated by angle ∂ as many number of times as the number of connection links in the set. This gives the points 930 as shown in FIG. 9C on the circumference of both clusters 901 and 902, which are then joined to make one set of connection links made up of several connection links with their own appearances corresponding to different categories of data message flows.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

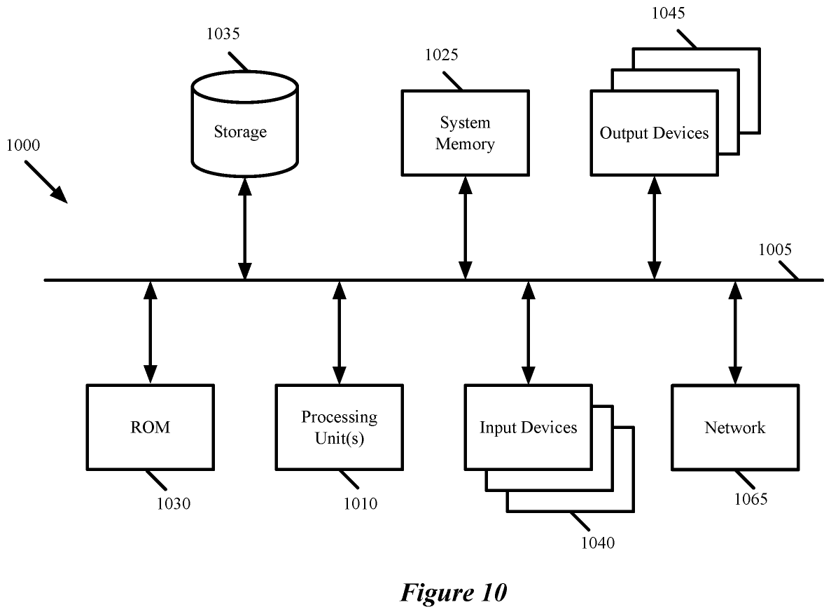

FIG. 10 conceptually illustrates a computer system 1000 with which some embodiments of the invention are implemented. The computer system 1000 can be used to implement any of the above-described computers and servers. As such, it can be used to execute any of the above described processes. This computer system includes various types of non-transitory machine readable media and interfaces for various other types of machine readable media. Computer system 1000 includes a bus 1005, processing unit(s) 1010, a system memory 1025, a read-only memory 1030, a permanent storage device 1035, input devices 1040, and output devices 1045.

The bus 1005 collectively represents all system, peripheral, and chipset buses that communicatively connect the numerous internal devices of the computer system 1000. For instance, the bus 1005 communicatively connects the processing unit(s) 1010 with the read-only memory 1030, the system memory 1025, and the permanent storage device 1035.

From these various memory units, the processing unit(s) 1010 retrieve instructions to execute and data to process in order to execute the processes of the invention. The processing unit(s) may be a single processor or a multi-core processor in different embodiments. The read-only-memory (ROM) 1030 stores static data and instructions that are needed by the processing unit(s) 1010 and other modules of the computer system. The permanent storage device 1035, on the other hand, is a read-and-write memory device. This device is a non-volatile memory unit that stores instructions and data even when the computer system 1000 is off. Some embodiments of the invention use a mass-storage device (such as a magnetic or optical disk and its corresponding disk drive) as the permanent storage device 1035.

Other embodiments use a removable storage device (such as a flash drive, etc.) as the permanent storage device. Like the permanent storage device 1035, the system memory 1025 is a read-and-write memory device. However, unlike storage device 1035, the system memory is a volatile read-and-write memory, such a random access memory. The system memory stores some of the instructions and data that the processor needs at runtime. In some embodiments, the invention's processes are stored in the system memory 1025, the permanent storage device 1035, and/or the read-only memory 1030. From these various memory units, the processing unit(s) 1010 retrieve instructions to execute and data to process in order to execute the processes of some embodiments.

The bus 1005 also connects to the input and output devices 1040 and 1045. The input devices enable the user to communicate information and select commands to the computer system. The input devices 1040 include alphanumeric keyboards and pointing devices (also called “cursor control devices”). The output devices 1045 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 10, bus 1005 also couples computer system 1000 to a network 1065 through a network adapter (not shown). In this manner, the computer can be a part of a network of computers (such as a local area network (“LAN”), a wide area network (“WAN”), or an Intranet, or a network of networks, such as the Internet. Any or all components of computer system 1000 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A graphical user interface (GUI) for displaying a visual representation of machines in a set of one or more datacenters, the GUI comprising:
a display area;
a graph comprising a plurality of clusters and different pluralities of connection links between different pairs of clusters;
each cluster representing a set of machines in the set of datacenters; and
each plurality of connection links between a pair of clusters (i) representing data message flows exchanged between machines in the pair of clusters and (ii) comprising at least two different sets of connection links that are displayed using different appearances corresponding to different categories of data message flows and indicating a quantity of data message flows.

2. The GUI of claim 1, wherein the plurality of clusters are generated based on an analysis of data message flows exchanged between the machines in the set of datacenters.

3. The GUI of claim 1, wherein the each plurality of connection links comprises a first number of connection links representing a larger, second number of data message flows represented by the plurality of connection links such that the first number is proportionally smaller to the second number.

4. The GUI of claim 1, wherein:
a set of middlebox service rules are applied to the data message flows as they traverse the set of datacenters, and
the different categories of data message flows comprise different actions applied to the data message flows based on the set of middlebox service rules.

5. The GUI of claim 4, wherein:
the set of middlebox service rules is a set of firewall rules, and
a particular plurality of connection links between a particular pair of clusters displayed in the display area comprises (i) a first set of connection links displayed using a first appearance corresponding to allowed data message flows exchanged between machines in the particular pair of clusters, (ii) a second set of connection links displayed using a second appearance corresponding to blocked data message flows exchanged between the machines in the particular pair of clusters, and (iii) a third set of connection links displayed using a third appearance corresponding to data message flows exchanged between the machines in the particular pair of clusters that were applied a default firewall rule.

6. The GUI of claim 5, wherein the first set of connection links comprises a first number of connection links indicating a first quantity of the allowed data message flows, the second set of connection links comprises a second number of connection links indicating a second quantity of the blocked data message flows, and the third set of connection links comprises a third number of connection links indicating a third quantity of the data message flows that were applied the default firewall rule.

7. The GUI of claim 6, wherein the first, second, and third appearances comprise one or more of (i) different colors, (ii) different solid and dashed lines, and (iii) different thicknesses of lines.

8. The GUI of claim 1, wherein the display area displays additional information regarding a particular plurality of connection links between a particular pair of clusters after the GUI detects a cursor action at a particular location in the display area that is within a threshold distance of the particular plurality of connection links.

9. The GUI of claim 8, wherein detecting the cursor action comprises identifying a cursor click operation at the particular location within the threshold distance of the particular plurality of connection links.

10. The GUI of claim 9, wherein the cursor click operation comprises a single right or left click operation.

11. The GUI of claim 9, wherein the cursor click operation comprises a double right or left click operation.

12. The GUI of claim 8, wherein the additional information comprises data indicative of a number of data message flows exchanged between the particular pair of clusters and numbers of data message flows represented by the at least two different sets of connection links.

13. The GUI of claim 1, wherein the pluralities of connection links are only displayed in the graph at one or more particular zoom levels of the display area.

14. The GUI of claim 13, wherein:
at a first zoom level, the graph does not comprise individual machines of the plurality of clusters, and
at a closer, second zoom level, the graph comprises the individual machines of the plurality of clusters.

15. The GUI of claim 1, wherein:
the graph further comprises individual machines of the pairs of clusters, and
after detecting a cursor click operation at a particular location within a threshold distance of a particular machine, the graph is updated to remove the pluralities of connection links and to comprise a particular set of connection links representing data message flows exchanged between the particular machine and other machines in the set of datacenters.

16. The GUI of claim 15, wherein each data message flow associated by the particular machine is represented by a connection link displayed from the particular machine to another machine associated with the data message flow.

17. The GUI of claim 16, wherein the particular set of connection links comprises connection links displayed using the different appearances corresponding to the different categories of data message flows.

18. The GUI of claim 1, wherein each plurality of connection links is displayed in the graph as a plurality of parallel lines between a pair of clusters.

19. The GUI of claim 1, wherein a first plurality of connection links includes a first number of connection links, and a second plurality of connection links includes a different, second number of connection links.

20. The GUI of claim 1, wherein each plurality of connection links comprises a same number of connection links.

21. A method for displaying a visual representation of machines in a set of one or more datacenters in a graphical user interface (GUI), the method comprising:
generating a plurality of clusters, each cluster representing a set of machines in the set of datacenters; and
displaying in a display area of the GUI a graph comprising the plurality of clusters and different pluralities of connection links between different pairs of clusters, each plurality of connection links between a pair of clusters (i) representing data message flows exchanged between machines in the pair of clusters and (ii) comprising at least two different sets of connection links that are displayed using different appearances corresponding to different categories of data message flows and indicating a quantity of data message flows.
